(19) United States
(12) Patent Application Publication
(10) Pub. No.: US 2019/0188513 A1
(43) Pub. Date: Jun. 20, 2019

(54) SYSTEMS AND METHODS FOR OBJECT DESKEWING USING STEREOVISION OR STRUCTURED LIGHT

(71) Applicant: Datalogic USA Inc., Eugene, OR (US)

(72) Inventors: Justin Beghtol, Santa Ana, CA (US); Weston Dean Turner, Eugene, OR (US)

(21) Appl. No.: 15/849,355

(22) Filed: Dec. 20, 2017

(51) Int. Cl. G06K 9/32; G06K 9/42; G06T 7/50; G06F 3/03; G06K 9/38

(52) U.S. Cl. CPC G06K 9/3275; G06K 9/42; G06K 9/38; G06F 3/03; G06T 7/50

(57) ABSTRACT

A system and method of deskewing an image of an object to be identified is disclosed. In a first embodiment, a first image and a second image are captured using a stereoscopic camera, and features are extracted from each of the first and second images. The extracted features may be matched and depths for each of the matched features may be calculated. Alternatively, a structured light pattern may be projected to a scene and reflections of the light pattern may be sensed. Depth information of the sensed light pattern may be calculated. In both embodiments, a region-of-interest inclusive of the object may be selected and skew of the region-of-interest may be calculated using depth information for the sensed light pattern and/or correlated points within the region. The region-of-interest may be deskewed based on the calculated skew. Visual pattern matching may be performed to identify the object in the deskewed region-of-interest.

### BACKGROUND

Keeping track of objects passing through a checkout counter is imperative in a retail environment. Or, more generally, every logistical system has to identify and generate entry records for objects during transit, storage, and transitions in between. Computer implemented object tracking systems detect various types of identifying marks or patterns typically placed on or in the packaging of products or on the products themselves to identify respective objects and to trigger other computer processing based on such identification. The tracking systems detect and identify the identifying marks through various means, such as an optical detection, laser detection, RFID, etc. At the back-end, the object tracking systems may use a visual pattern recognition (ViPR) algorithm, which extracts visible features of an object and searches for matching features in a set of known or labeled objects (also known as a model set) in order to recognize or identify the object.

However, there are several technical shortcomings in the traditional object tracking systems. The visual pattern algorithm's effectiveness is degraded by off-normal (i.e., non-perpendicular) views of object surfaces because reference images used to produce model sets are generally acquired with an object's surfaces normal to a camera view (aim vector). For example, a cuboid object viewed such that its faces are not orthogonal to the camera's aim vector may have fewer feature matches to a corresponding known or labeled object than the same object when rotated such that faces of the object are normal to the camera's aim vector. Thus, the off-normal presentation of objects decreases reliability and accuracy of object identification by the visual pattern recognition algorithm. A conventional solution to the off-normal presentation problem is to acquire multiple reference images at multiple angles. However, the use of multiple angles of objects (i) greatly increases the size of a model set used to match the skewed angles, and (ii) increases search time for item matching within the larger model set. In addition, a digital watermark decoding algorithm is severely degraded by off-normal presentation of an object's surface. Decoding of watermark symbols may become impossible when watermarked surfaces are too far off-normal to the camera view.

In the case of a retail environment, an object identification system may be configured to identify objects left inside shopping cards. A conventional object tracking system may use single monochrome images with visual pattern recognition based on scale invariant feature transformation (SIFT) pattern matching. Pattern matching becomes significantly more complex when the patterns are at a non-normal viewing angle of detecting camera. For example, within the shopping cart, objects to be identified may be at a skewed or non-normal angle to a camera, fabric and background objects may introduce confusable features, and products at far distances are to be excluded. These challenges make the use of pattern matching for non-normal viewing angles of object

### SUMMARY

To reduce or avoid the problem of object identification when an object is skewed relative to a camera view, computationally efficient object identification system and method for identifying object surfaces at off-normal or non-normal views of a detecting camera are provided. More specifically, to digitally deskew an image such that an off-normal object surface view appears to be orthogonal to a visual pattern recognition algorithm, image processing may be performed by using features identified on the object to deskew the object. That is, an image of the object may be deskewed to cause an image of the object to appear as if the image was captured by a camera orthogonal to the object surface.

One embodiment of a method of identifying object may include capturing a first image having a first depth-of-field and a second image having a second depth-of-field of a scene containing an object. Features of the object may be extracted from each of the first and second images. The first image may be correlated with the second image using the extracted features from the respective images, and the depths of the extracted features may be calculated. At least one region-of-interest from the scene inclusive of the object may be selected. Skew of the region-of-interest may be determined based on the depths of the extracted features. The region-of-interest may be deskewed based on the determined skew, and the object may be identified by pattern matching using the deskewed object.

One embodiment of a system for identifying an object may include a first optical component having a first depth-of-field, and a second optical component having a second depth-of-field. A sensor may be configured to capture a first image having a first depth-of-field and a second image having a second depth-of-field. A processing unit may be in communication with the sensor. The processing unit may be configured to extract features of the object from each of the first and second images. The first image may be correlated with the second image using the extracted features from the respective images Depth of the extracted features may be calculated, and at least one region-of-interest may be selected from the scene inclusive of the object. A skew of the region-of-interest may be determined based on the depths of the extracted features. The region-of-interest may be deskewed based on the determined skew. A pattern match may be performed to identify the object using the deskewed object captured in the image.

One embodiment of a method of identifying an object may include transmitting a structured light pattern onto a scene in which an object is positioned, and sensing the structured light pattern on the scene. Depth may be determined based on the sensed structured light. At least one region-of-interest inclusive of the object may be selected from the scene. The skew of the region-of-interest may be determined based on the depths of points within the region-of-interest. The region-of-interest may be deskewed based on the determined skew. The object may be identified by pattern matching using the deskewed region-of-interest.

### BRIEF DESCRIPTION OF THE DRAWINGS

Illustrative embodiments of the present invention are described in detail below with reference to the attached drawing figures, which are incorporated by reference herein and wherein:

FIG. 1A is an illustration of a first illustrative retail checkout environment in which a stereoscopic camera system combined with a deskewing algorithm is used to deskew a surface at an off-normal view of an object left in a shopping cart;

FIG. 1B is an illustration of second illustrative retail checkout environment in which a structured light pattern projection and detection system combined with a deskewing algorithm is used to deskew a surface at an off-normal view of an object left in a shopping cart;

FIG. 2A is an illustration of a first illustrative object identification environment in which a stereoscopic camera system combined with a deskewing algorithm is used to deskew a surface at an off-normal view of an object left in a shopping cart;

FIG. 2B is an illustration of second illustrative object identification environment in which a structured light pattern projection and detection system combined with a deskewing algorithm is used to deskew a surface at an off-normal view of an object left in a shopping cart;

FIG. 3A is an illustration of a first hand-held object scanner in which a stereoscopic camera system combined with a deskewing algorithm is used to deskew a surface at an off-normal view of an object left in a shopping cart;

FIG. 3B is an illustration of second hand-held scanner in which a structured light pattern projection and detection system combined with a deskewing algorithm is used to deskew a surface at an off-normal view of an object left in a shopping cart;

FIG. 4A is an illustration of a first illustrative object identification system using a stereoscopic camera system;

FIG. 4B is an illustration of a second illustrative object identification system using a structured light pattern projection and detection system;

FIG. 5 is an illustration of illustrative software modules configured to perform object detection using the image skewing principles described herein;

FIG. 6A is a flow diagram of a first illustrative object identification process using a stereoscopic camera system;

FIG. 6B is a flow diagram of a second illustrative object identification process using a structured light pattern projection and detection system;

FIG. 7 is an illustration of a result of having a deskewed image of an object, where the object appears off-normal to an actual camera that captures the image, but appears normal to a virtual camera after the image of the object is deskewed;

FIGS. 8A and 8B are images of illustrative images of a skewed and a deskewed object, where the deskewed object image is used to improve visual pattern recognition; and

FIGS. 9A and 9B are images of illustrative images of a skewed and a deskewed object, where the deskewed object image is used to improve watermark matching.

### DETAILED DESCRIPTION OF THE DRAWINGS

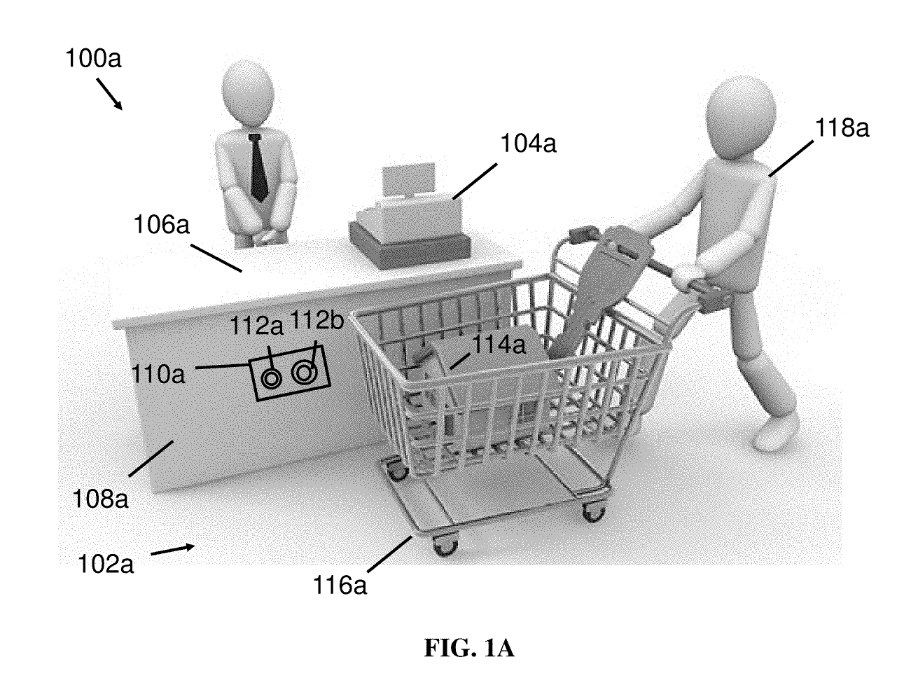

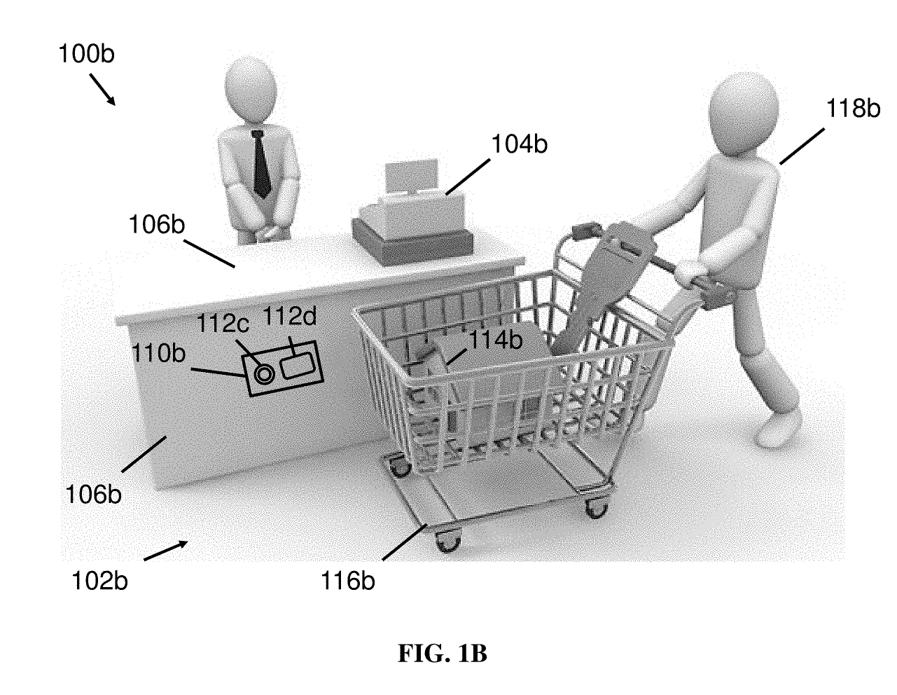

With regard to FIG. 1A, an illustration of a first illustrative retail checkout environment 100a is shown. The retail checkout environment 100a may include a checkout lane 102a with a point-of-sale (POS) register 104a, a checkout counter 106a, and a checkout lane wall 108a. In an embodiment, a stereoscopic camera system 110a may be disposed on the checkout lane wall 106a and face the checkout lane 102a. It should be understood that the stereoscopic camera system may alternatively be positioned above the checkout lane 102a, beneath the checkout line, or anywhere else where objects within a shopping cart may be imaged by a camera. As described in further detail below, the stereoscopic camera system 110a may include a pair of camera modules 112a and 112b for capturing a stereoscopic pair of digital images of a scene containing an object 114a in a shopping cart 116a. In operation, the camera modules 112a and 112b are generally oriented to be scanning for objects on a bottom shelf beneath the basket of the shopping cart 116a to make it easier for a customer or ensure that objects are not mistakenly or intentionally left on the bottom shelf, but may also be within the basket or elsewhere on the shopping cart. A processor within the point-of-sale register 104a or any other computing device (not shown) may process the images using one or more image processing algorithms to determine depth information of an object in the scene (in this case the shopping cart 116a and the object 114a therein), and deskew a region-of-interest that contains the object 114a in the images to enable identification of the object 114a using the depth information.

As sometimes occurs in retail stores, the object 114a may have been left inadvertently left in the shopping cart 116a by a customer instead of putting the object on the checkout counter 106a such that the object 114a has to be accounted for by the point-of-sale register 104a. As also sometimes occurs, the object 114a may have been deliberatively left in the shopping cart 112a by a customer 118a based on an authorization or request from an operator at the POS register 104a that the object 114a can be scanned while in the shopping cart 116a due to the object 114a being large or heavy. To accommodate determining the object 114a, an image deskewing process may be performed because a surface of the object 114a may not be directly facing or normal (i.e., perpendicular) to the stereoscopic camera system 110a, and each of the camera modules 112a and 112b in the stereoscopic camera system 110a may capture off-normal views of the object 114a. The deskewing may normalize or straighten an image of the object 114a such that the deskewed image of the object may be compared to pre-established or model image(s) of objects stored in a local or a remote database, i.e. a model set, to identity the object 114a using feature, pattern, or image recognition.

With regard to FIG. 1B, an illustration of a second illustrative second retail checkout environment 100b is shown. The second retail checkout environment 100b is similar to the first retail environment 100a, but uses a different deskewing technology to capture an off-normal view of an object 114b in a shopping cart 116b. Instead of using the stereoscopic camera system 110a of FIG. 1A, the second retail checkout environment 100b may use a structured light pattern projection and detection system 110b, which may include a camera module 112c and a structured light pattern illuminator 112d that generates a structured light pattern that is illuminated toward the scene and onto the object 114b. In operation, one or more camera modules 112c may be used to detect reflection and scattering of the structured light pattern from the object 114b to determine depth information of the object 114b in an image. Again, the object 114b may be located on the bottom shelf beneath the basket, and the camera 110b may be oriented to capture images of the bottom shelf of the shopping cart 116b. A processor (not shown) may perform back-end algorithmic calculations from the captured structured light pattern to determine skew of the object in the image, and perform deskewing over a region-of-interest (e.g., a portion of the entire image) containing the object 114b using the depth information, as further presented herein.

One having ordinary skill in the art should understand that the various components of the first and second retail checkout environments 100a, 100b are not mutually exclusive, and may be performed concurrently with one another. For example, an object identification system may be a combination of both (i) stereoscopic camera system 110a, and (ii) a structured light pattern projection and detection system 110b, where the systems 110a, 110b may operate as complementary or redundant systems.

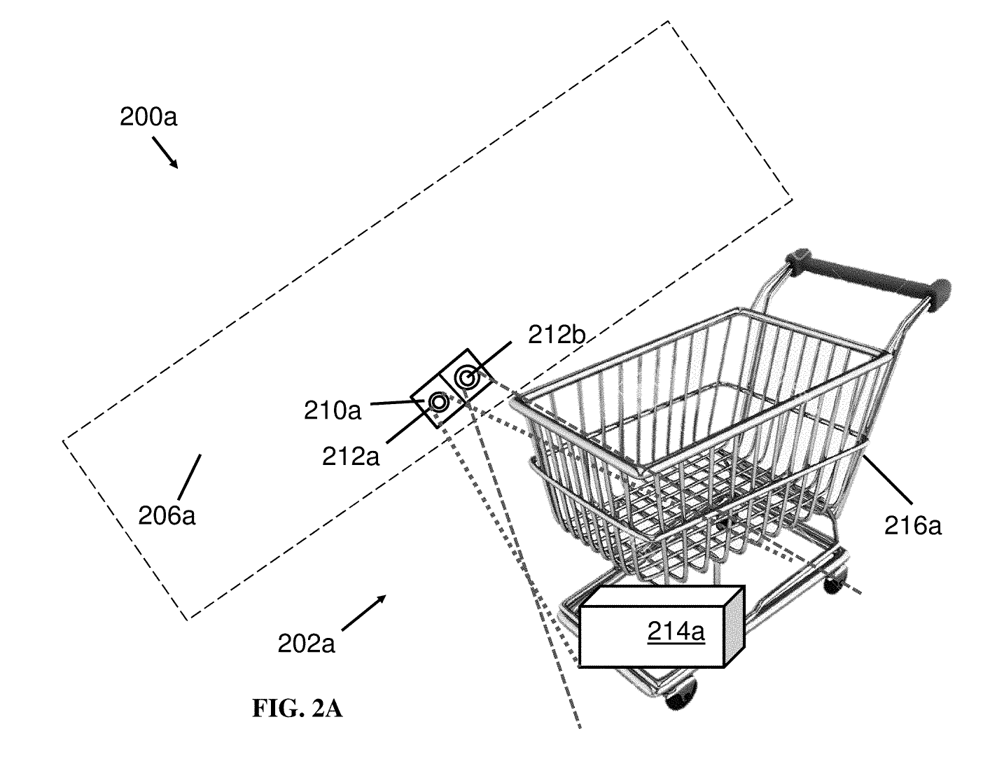

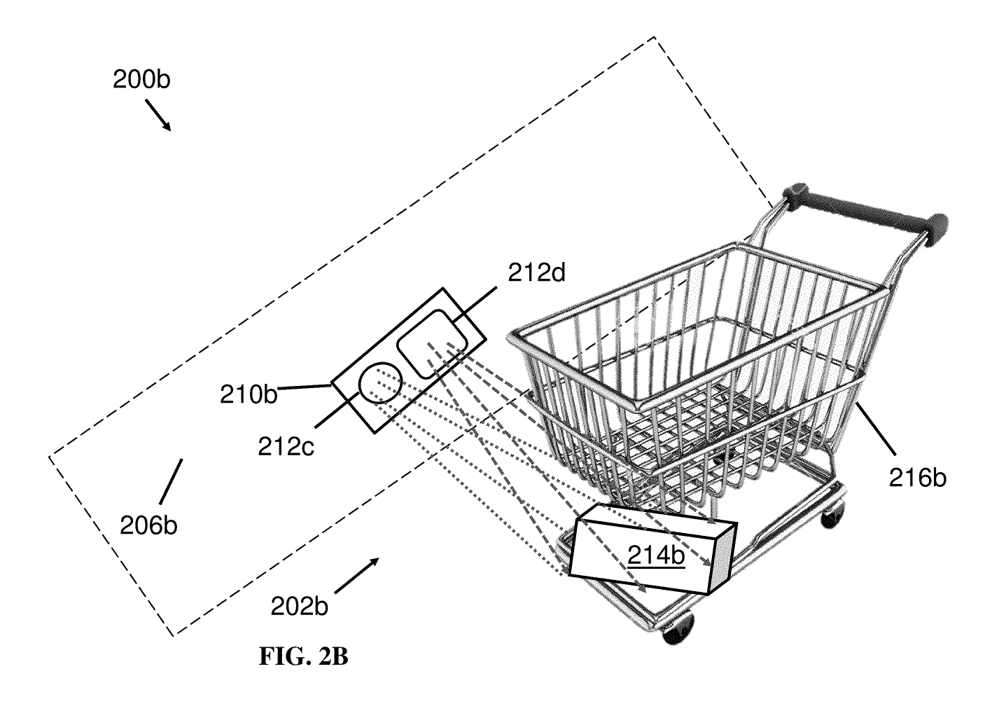

With regard to FIG. 2A, an illustration of first illustrative object identification environment 200a is shown. The object identification environment 200a may be within the retail checkout environment 100a, as described with regard to FIG. 1A. The object identification environment 200a may include a checkout lane 202a next to a checkout lane wall 206a on which a stereoscopic camera system 210a may be disposed to face the checkout lane 202a. An object 214a may be positioned within a shopping cart 216a in the checkout lane 202a. The object 214a may either inadvertently or deliberatively be left in the shopping cart 216a by a customer.

The stereoscopic camera system 210a may include a first camera module 212a having a first focal length and a second camera module 212b having a second focal length. As shown herein, the first camera module 212a may have a shorter focal length than the second camera module 212b. That is, the first camera module 212a may have a shallower depth-of-field and make take higher resolution or more focused pictures in the near field compared to the second camera module 212b that may have a deeper depth-of-field that may take higher resolution or more focused pictures in the far field than the first camera module 212a. However, one having ordinary skill in the art understands that the relative depths-of-field of the first camera module 212a and the second camera module 212b are merely illustrative, other depths-of-field should be considered within the scope of this disclosure. For example, the first camera module 212a and the second camera module 212b may have the same depth-of-field or opposite depths-of-field than previously described.

As detailed below, a first image with a first depth-of-field from the first camera module 212a and a second image with a second depth-of-field from the second camera module 212b may be processed by an associated computing system (not shown), such as a point-of-sale register or other computing device, such as a remote server, to correlate features extracted from the first and second images. The associated computing system may also calculate the depth of the extracted features in each of the first and second images and select a region-of-interest containing one or more objects. Based on the depth of the extracted features, the associated computing system may determine a skew of a region of interest and deskew the region-of-interest based on the determined skew. After the images of the one or more objects have been deskewed, the associated computing system may perform pattern matching against a model set of images of objects to identify the one or more objects.

With regard to FIG. 2B, an illustration of a second illustrative object identification environment 200b is shown. The second illustrative object identification environment 200b is similar to the first object identification environment except for a structured light pattern projection and detection system 210b inclusive of a camera module 212c and a structured light pattern illuminator 212d underlying deskewing algorithms, which may be used instead of the stereoscopic camera system 210a of the first illustrative environment 200a.

The structured light pattern projection and detection system 210b includes a camera module 212c and structured light source 212d. The structured light source 212d may project a light pattern, such as multiple dots of light or other light pattern (e.g., vertical and horizontal stripes of light), on an object 214b left on a shopping cart 216b. The camera module 212c may capture a reflection and scattering of the light pattern from the object 214b. A computing system (not shown), such as a point-of-sale register or other computing system, may determine depth information of an image captured of the scene containing the object 214b. It should be understood that the structured light pattern may illuminate an entire scene, include any other objects within the shopping cart 216b.

The associated computing system may select a region-of-interest within a captured image, and determine skew for the region-of-interest based on depth information of the imaged structured light pattern within the region-of-interest. The associated computing system may then deskew the region-of-interest using the determined skew. Once the region-of-interest has been deskewed, the associated computing system may execute one or more visual pattern recognition algorithms to identity the one or more objects or a watermark decoding algorithm to decode watermarks on surface(s) of the object(s), as further described herein.

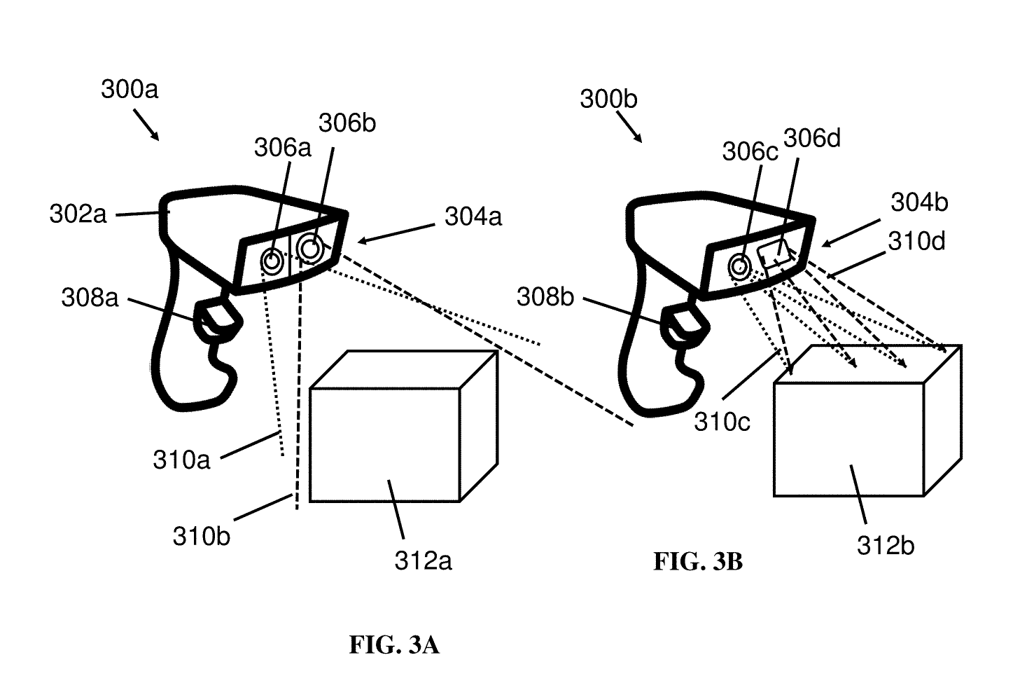

With regard to FIG. 3A, an illustration of first illustrative object identification environment 300a is shown. The first illustrative object identification environment 300a may include a handheld scanner 302a containing a stereoscopic camera system 304a having a first camera module 306a and a second camera module 306b. The handheld scanner 302a may include a trigger 308a to enable an operator to manually activate the handheld scanner 302a to image a scene. Once activated, the first camera module 306a may capture a first image with a first depth-of-field 310a and the second camera module 306b may capture a second image with a second depth-of-field 310b. In this illustrative embodiment, it is shown that the first depth-of-field 310a has a shallower depth-of-field than the second depth-of-field 310b. However, one having ordinary skill in the art understands that this relative depth-of-field is merely illustrative and other relative depths-of-fields should be considered within the scope of this disclosure.

A first image of a scene may include an object 312a, and a second image may also capture the object 312a within the scene. An associated computing system, such as point-of-sale register, may (i) extract features, as further described herein, from each of the first and second images and (ii) correlate the first and second images using the extracted features. The associated computing system may further calculate depths of the extracted features, select a region-of-interest containing the object 312a from an image of the scene, and determine the skew of the region-of-interest of the based on the respective depths of the extracted features. Using the determined skew, the associated computing system may deskew the region-of-interest and perform pattern matching to identify the object 312a in the deskewed region-of-interest.

With regard to FIG. 3B, an illustration of a second illustrative object identification environment 300b is shown. The second illustrative environment 300b may be similar to the first illustrative environment 300a with the exception of the object identification hardware and the accompanying software module. In the second illustrative environment 300b, instead of the stereoscopic camera system 304a, a structured light pattern projection and detection system 304b inclusive of a camera module 306c and a structured light pattern projector 306d may be utilized. The structured light pattern projection and detection system 304b may be activated upon a user pressing a trigger 308b, for example. Upon activation, the structured light pattern projector 306db may output a pattern of light 310d onto a scene containing an object 312b. The camera module 306c may receive light reflections and scattering 310c of the projected pattern of light 310d. Based on the received light reflections and scattering 310c, an associated computing system may determine depth information of the scene. The associating computing system may also select a region-of-interest in an image containing the object 312b, and determine skew of an image of the object 312b in the region-of-interest based on the depth information. Using the determined skew, the associated computing system may deskew the region-of-interest and perform pattern matching to identify the object 312b or execute a watermark decoding algorithm to decode a watermark, such as a digital watermark, disposed on a surface of the object 312b.

One having ordinary skill in the art should understand that the illustrative environments 300a and 300b are merely and not intended to be limiting to this disclosure. For example, the above embodiments primarily describe a retail checkout environment, and these embodiments can be equally application to other environments, such as logistic processing, package processing and delivery, and/or any other types of environment where various objects are identified and tracked.

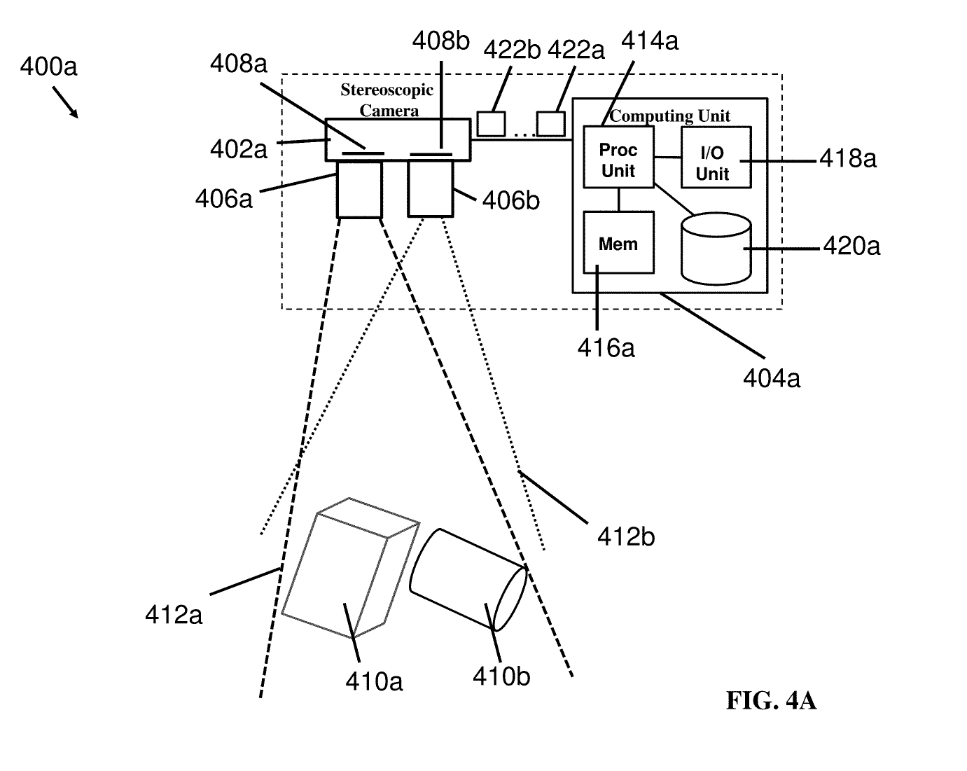

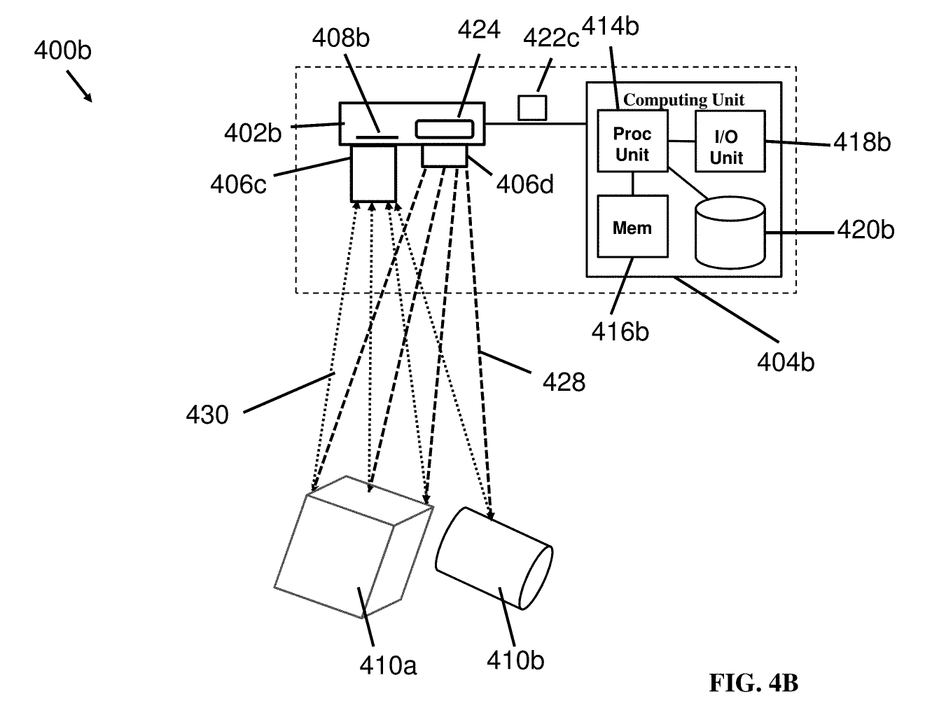

With regard to FIG. 4A, an illustration of first illustrative object identification system 400a is shown. The first illustrative object identification system 400a may include a stereoscopic camera system 402a and a computing unit 404a. In some embodiments, the stereoscopic camera system 402a and the computing unit 404a may be components of a retail checkout environment, such as one illustrated in FIG. 1A. In these embodiments, the stereoscopic camera system 402a may be mounted to a checkout lane wall facing a checkout lane from where shopping carts pass, and the computer 404a may be checkout register. Alternatively, the camera system 402a may be suspended over the checkout lane or elsewhere positioned. In other embodiments, the first illustrative object identification system 400a may be a part of a logistic processing environment implemented to identify and track objects passing through different points in a logistic chain. For example, the first object identification system 400a may be used as a package identifier and tracker within a package delivery system.

The stereoscopic camera system 402a may include a first camera module 406a with a first pixel array or optical sensor 408a and a second camera module 406b with a second pixel array or optical sensor 408b. One or more subsets (not shown) of the first pixel array 408a may capture a first image of a scene containing objects 410a and 410b (collectively 410), and one or more subsets (not shown) of the second pixel array 408b may capture a second image of the scene containing the same objects 410. The first image may have a first depth-of-field depending upon a first focal length of the first camera module 106a, and the second image may have a second depth-of-field depending upon a second focal length of the second camera module 406b. A first field-of-view of the first camera module 406a is shown as 412a, and a second field-of-view of the second camera module 406b is shown as 412b. In some embodiments, the first field-of-view 412a may be narrower than the second field-of-view 412b. In an embodiment, the first focal length of the first camera module 406a may be longer than the second focal length of the second camera module 406b.

The computing unit 404a may include a processing unit 414a, a non-transitory memory 416a, an input/output (I/O) unit 418a, and a storage unit 420a. The processing unit 414a may include one or more processors of any type, where the processor(s) may receive raw image data image data from the first pixel array 408a. The non-transitory memory 416a may be any type of random access memory (RAM) from which the processing unit 414a may access raw or processed image data and write one or more processor outputs thereto. The I/O unit 418a may handle communications with devices, such as the stereoscopic camera system 402a, the Internet, and/or any other devices using one or more communications protocols, as understood in the art. The storage unit 420a may store software modules implementing one or more image processing and visual pattern recognition algorithms, including a model set of objects that is utilized by the visual pattern recognition algorithms to identify objects imaged by the stereoscopic camera 402a. Although the computing unit 404a is shown as a single unit in the illustrative system 400a, one having ordinary skill in the art should understand multiple computing devices, including one or more distributed computers, may be used to accomplish the functionality described herein. Furthermore, one having ordinary skill in the art understands that there may be multiple layers of computer processing, that is, a low intensity computer processing may be conducted locally, and more complex computer processing may be conducted on the cloud.

As previously described, the first pixel array 408a may capture a first image of a scene containing the objects 410, and the second pixel array 408b may capture a second image of the scene. In some embodiments, the objects 410 may be in a shopping cart either stationary or passing through a shopping lane at a retail checkout. In other embodiments, the objects 410 may be passing on a conveyer belt of a logistical processing center or at the checkout counter. As shown herein, the camera module 406a may have a longer depth-of-field and the second camera module 406b may have a shorter depth-of-field. Furthermore, as the first and second camera modules 406a, 406b are at different locations, the first and second images may have different perspectives, which means that the viewing perspective by the first camera module 406a may be slightly different from the viewing perspective of the second camera module 406b. In an embodiment, the camera modules 406a and 406b may be stereoscopically aligned. Each of the first and second pixel arrays 408a, 408a may transmit first and second sets of image data 422a and 422b (collectively 422) representative of first and second images to the computing unit 404a for processing thereby.

The computing unit 404a may receive the first and second sets of image data 422. In some embodiments, the first and second sets of image data 422 may come as a raw image data to the computing unit 404a. In other embodiments, the stereoscopic camera system 408a may perform some rudimentary processing and the computing unit 404a may receive the first and second images as semi-processed image data. The processing unit 414a may extract features from the first image and second images using one or more image processing algorithms. For example, the processing unit may use a scale-invariant feature transform (SIFT) algorithm, as understood in the art, to extract one or more features from images of the respective scenes. The features in the respective scenes may include corners, edges, ridges, grooves, and/or different planes of the objects 410. However, one having ordinary skill in the art understands that the SIFT algorithm is merely illustrative and other image processing algorithms capable of identifying features of objects should be considered to be within the scope of this disclosure.

The processing unit 414a may then execute one or more stereo-matching algorithms to match the features from each of the first and second sets of image data 422. In some embodiments, the processing unit 414a may skip higher resolution features from the more zoomed in image, in this case, from the second image. To further improve upon the match set, the processing unit 414a may remove the outliers in the Y-space. The processing unit 414a may scale the remaining extracted matching features. That is, features without the higher resolution features and without the Y-space outliers may be matched to a common co-ordinate space. Furthermore, the processing unit 414a may then use the matching features as stereo correspondences to compute depth for each matching point. The processing unit 414a may be able to calculate depths for the matched points (for example, SIFT match points) in each of the first and second images. However, these calculated depths should be sufficient to detect planes and skew of the planes relative to the stereoscopic camera system 402a.

The processing unit 414a may select a region-of-interest of an image of the scene, where the region-of-interest may include the objects 410. Using the depths of the matched points for each of the first and second sets of image data (i.e. the far field image and the near field image, respectively), the processing unit 414a may calculate the skew for the region-of-interest. For example, the processing unit 414a may calculate the individual skew for each of the matched points within the region-of-interest, and then calculate the skew for the region-of-interest based on the individual skews. The processing unit 414a may then deskew the region-of-interest based on the calculated skew of the region-of-interest. For example, if the region-of-interest includes a skewed plane, the processing unit 414a may calculate the depths for each of the matched points along the plane, and compute a perspective transform to normalize the skewed plane. In addition to deskewing a region-of-interest, calculation of depths for the matched points allows the system 400a to realize other benefits as well. For example, the system 400a may differentiate foreground and background features and exclude items beyond a predetermined distance, for example. An illustrative algorithm for performing stereo correspondence between disparate focal length images is provided hereinbelow.

Once the region interest containing the objects 410 has been deskewed, the processing unit 414a may identity the objects 410 using any object identification process, as understood in the art. As an example, the objects 410 may include a barcode, and the processing unit 414a may execute a barcode decoder algorithm to decode the barcode. As another example, the objects 410 may include a digital watermark, and the processing unit 414a may use digital watermark reader software to process and read the digital watermark. In some embodiments, the processing unit may use a visual pattern recognition algorithm to identify one or more features from the deskewed objects 410 by comparing the one or more features in a model set. In some embodiments, when the determined skew of the region-of-interest is below a threshold angle (e.g., less than about 10 degrees of skew), the processing unit 414a may perform visual pattern recognition without deskewing the region-of-interest.

With regard to FIG. 4B, an illustration of a second illustrative object identification system 400b is shown. The second illustrative object identification system 400b may include a structured light pattern projection and detection system 408b and a computing unit 404b. In some embodiments, the structured light sensing system 408b and the computing unit 404b may be components of a retail checkout environment, such as one illustrated in FIG. 1B. In these embodiments, the structured light sensing system 408b may be mounted a checkout lane wall facing a checkout lane via which shopping carts pass, and the computing unit 404b may be a checkout register or other computing system. In other embodiments, the second illustrative object identification system 400b may be part of a logistic processing environment implemented to identify and track object passing through different points in a logistic chain. For example, the second object identification system 400b may be used as a package identifier and tracker for packages moving on a conveyer belt within a package delivery system.

The structured light pattern projection and detection system 408b may include structured light pattern projector 406d with a structured light pattern source 424 and camera module 406c with a pixel array 408b. The light pattern projector 406d may project a structured light pattern 428, such as multiple dots of light, to a scene containing objects 410a and 410b (collectively 410). The camera module 406c may detect light reflection and scattering 430 of the structured light pattern 428. The camera system 402b may communicate sensed data 422c to the computing unit 404b to perform image and/or signal processing, including deskewing, as described herein. The sensed data 422c may include raw image data, filtered image data, or any sensed data, and may include the structured light pattern that is captured as reflected and/or scattered by the objects 410.

The computing unit 404b may include a processing unit 414b, a non-transitory memory 416b, an input/output (I/O) unit 418b, and a storage unit 420b. The processing unit 414b may include one or more processors of any type, where the one or more processors may receive the sensed data 422c from the structured light projection and detection system 402b and process the sensed data 422, as described hereinbelow. The non-transitory memory 416b may be any type of random access memory (RAM) that the processor from which the processing unit 414b may access the sensed data 422c, and write one or more processor outputs thereto. The I/O unit 418b may handle communications with devices, such as the structured light projection and detection system 402b, the Internet, and/or any other devices using one or more communications protocols, as understood in the art. The storage unit 420b may store software modules implementing one or more image processing and visual pattern recognition algorithms, including the model set for the visual pattern recognition algorithms. Although the computing unit 404b is shown as a single unit in the illustrative system 400b, one having ordinary skill in the art should understand multiple computing devices, including one or more distributed computers, may be used to accomplish the functionality described herein. Furthermore, one having ordinary skill in the art understands that there may be multiple layers of computer processing, that is, a low intensity computer processing may be conducted locally; and more complex computer processing may be conducted on the cloud.

As described above, the structured light projector 406d may project structured light 428 onto a scene containing objects 410 that are to be identified. The pixel array 408b within the camera 402b may detect reflection and scattering 430 of the projected structured light pattern 428. The sensed data 422c containing either or both the projection of the structured light pattern and the resultant reflection and scattering may be communicated to the computing unit 404b, where the processing unit 414b may determine depth information of object(s) in the scene based on the sensed data 422c. The processing unit 414b may then (i) select a region-of-interest based on depth information and (ii) determine skew of the region-of-interest based on the depth information of multiple points within the region-of-interest. The processing unit 414b may then deskew the region-of-interest using the determined skew.

Once the region-of-interest containing an image of the objects 410 has been deskewed, the processing unit 414b may identity the objects 410 using any object identification process, as understood in the art. As an example, the objects 410 may include a barcode, and the processing unit 414b may perform a barcode decoder algorithm to decode the barcode. As another example, the objects 410 may include a digital watermark, and the processing unit 414b may use digital watermark reader software to process and read the digital watermark. In some embodiments, the processing unit may use a visual pattern recognition algorithm to identify one or more features from the deskewed objects 410 by comparing the one or more features in a model set. In some embodiments, when the determined skew of the region-of-interest is below a threshold angle (e.g., about 10 degrees), the processing unit 414a may perform visual pattern recognition without deskewing the region-of-interest.

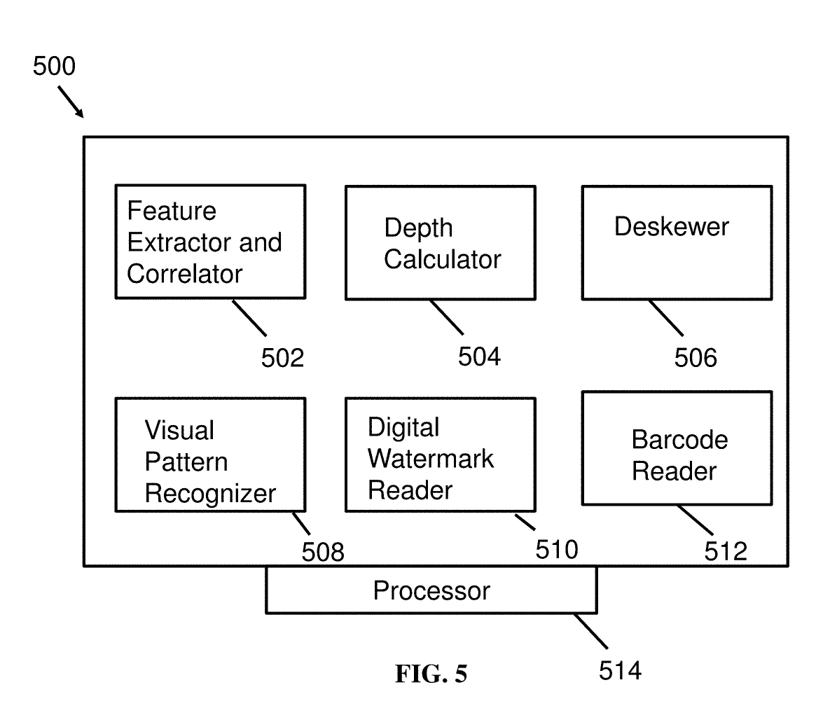

With regard to FIG. 5, a block diagram illustrative software modules 500 is shown. The illustrative software modules 500 may include a feature extractor and correlator module 502, a depth calculator module 504, a deskewer module 506, a visual pattern recognizer module 508, a digital watermark reader module 510, and a barcode reader module 512. The aforementioned software modules may be executed by a processor 514. It should be understood that additional and/or alternative software modules 500 may be utilized. Moreover, alternative combinations of the software modules 500 may be utilized.

The feature extractor and correlator module 502 may implement one or more image processing algorithms to extract features from images and use the extracted features to correlate the images (e.g., pair of stereoscopic images captured using different focal lengths). The extracted features may include corners and edges of one or more objects within the images. By using different focal lengths to capture and process images, in particular using SIFT pattern matching, subpixel resolution correspondences between images for use in stereo distance calculations may be made. As a result, (i) distance may be calculated and (ii) detection and correction of skewed objects may be made to improve recognition algorithms.

The depth calculator module 504 may calculate the depth of extracted features. For a system using a stereoscopic camera system, the depth calculator module 504 may calculate the depth of the matched features of two or more images. For a system using a structured light pattern, the depth calculator module 504 may calculate depth of various features within an object based upon reflection and scattering of a projected structured light pattern.

The deskewer module 506 may deskew a region-of-interest within one or more images based on the depths calculated by the depth calculator module 504. The visual pattern recognizer module 508 may recognize a visual pattern within a deskewed region-of-interest based on a model set. The digital watermark reader module 510 may read and decode digital watermark within a deskewed region-of-interest. The barcode reader module 512 may read and decode a barcode or another type of code such as a QR code within a region-of-interest.

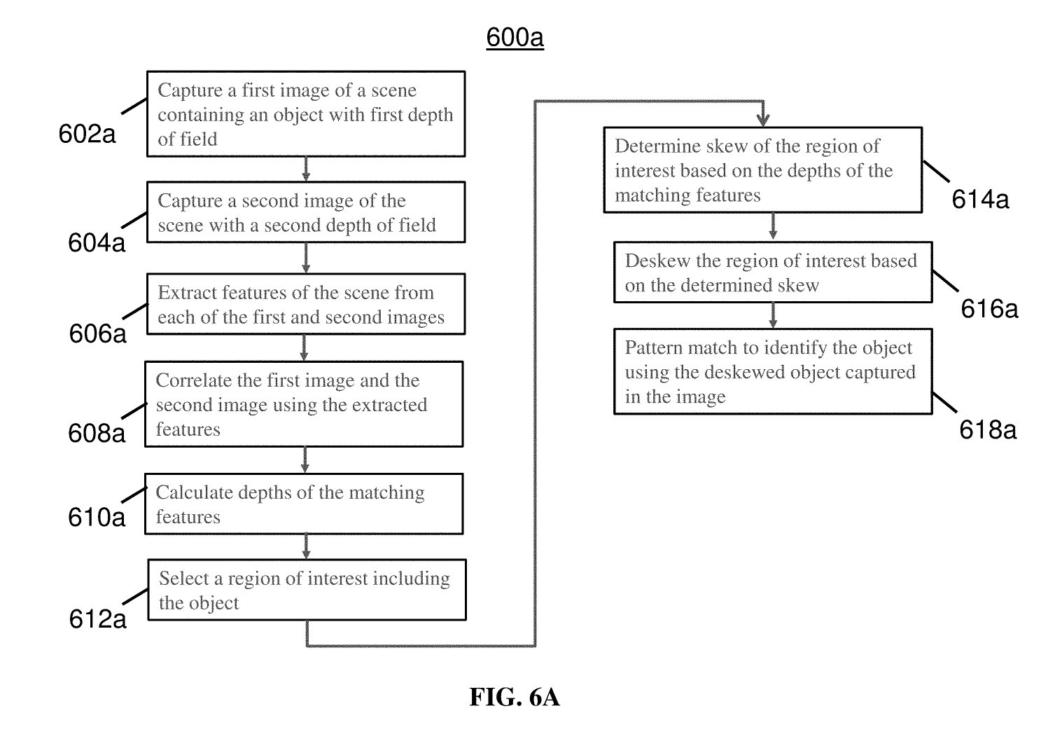

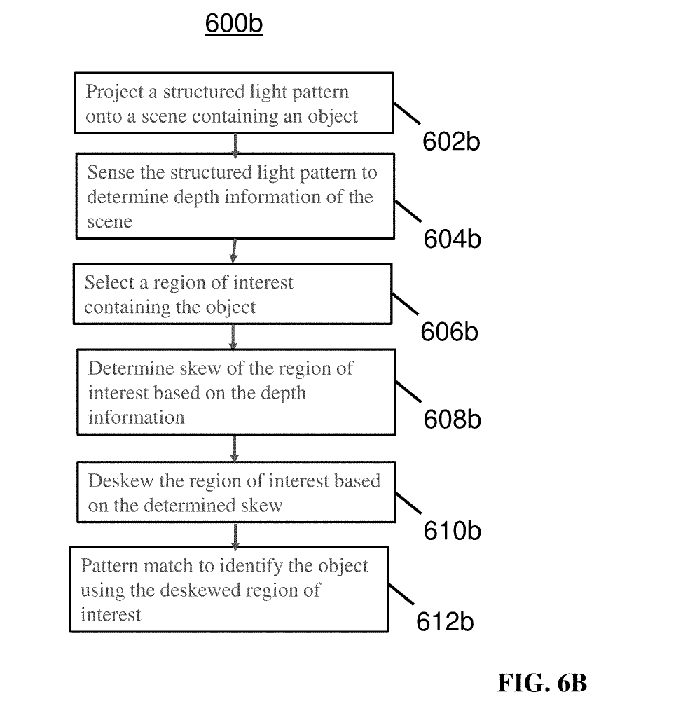

With regard to FIG. 6A, a flow diagram of a first illustrative object identification process 600a is shown. The process 600a may begin at step 602a, where a first camera of a stereoscopic camera system may capture a first image of a scene containing an object with first depth-of-field. At step 604a, a second camera of the stereoscopic camera system may capture a second image of the scene with a second depth-of-field. At step 606a, a processor may extract features of the scene from each of the first and second images. For example, the processor may use any type of image processing algorithm, such as a scale invariant feature transformation (SIFT) algorithm to identify features, such as edges and corners from each of the images. At step 608a, the processor may correlate the first image and the second image using the extracted features. The processor may, for example, match similar identified features from the first image to the second image. In some embodiments, the processor may remove features of a near field image having a higher resolution and/or outliers in the Y-scale and match the remaining features.

At step 610a, the processor may calculate depths of the matching features in each of the first image and the second image. At step 612a, the processor may select a region-of-interest including the object. At step 614a, the processor may determine the skew of the region-of-interest based on the depths of the matching features. For example, depth of various features in an object can be used to determine skew of the object in the image. At step 616a, the processor may deskew the region-of-interest based on the determined skew. At step 618a, the processor may perform pattern matching to identify the object using the deskewed object captured in the image using a model set. Such pattern matching is computationally efficient compared to conventional systems because (i) a database does not have to hold patterns in the object from multiple perspectives, and (ii) the processor does not have to perform multiple and complex comparisons for each of the multiple perspectives. In other words, a deskewed object can be identified with a simple model set and a few comparisons.

With regard to FIG. 6B, a flow diagram of a second illustrative object identification process 600b is shown. The process may begin at step 602b where a light source may project a structured light pattern onto a scene containing an object. At step 604b, an optical detector such as a camera may sense the structure light pattern to determine depth information of the scene. More specifically, the optical detector may capture the reflection and/or scattering of the projected structured light pattern to determine the depth of one or more objects or portions thereof in the scene. At step 606b, a processor may select a region-of-interest containing the object. At step 608b, the processor may determine the skew of the region-of-interest based on the depth information. More specifically, different points within the region-of-interest may reflect and/or scatter the respective portions of the projected structured light pattern differently based on the respective distance and orientation of the points from the light source. This type of differential reflection and/or scattering enables a processor to calculate depth of different points in the region-of-interest and subsequently determine skew of the region-of-interest (e.g., portion of image inclusive of an object). At step 610b, the processor may deskew the region-of-interest based upon the skew determined at step 608b. A step 612b, the processor may pattern match to identify the object using the deskewed region-of-interest.

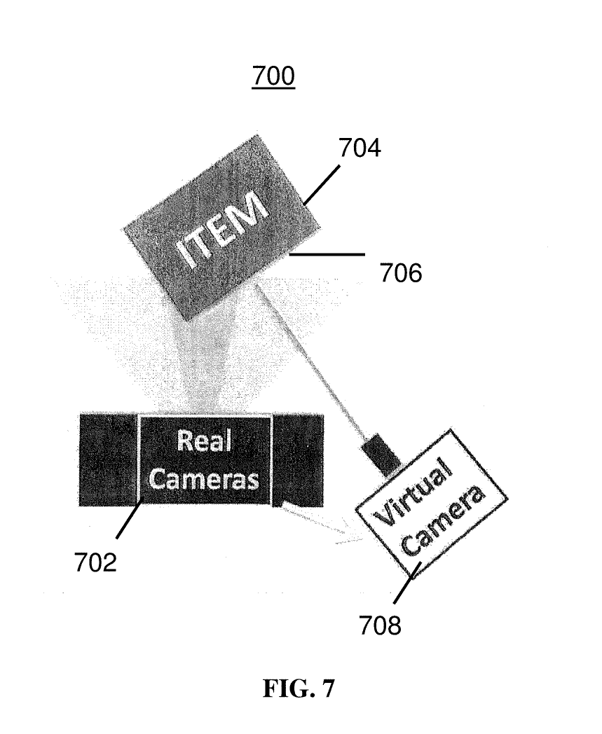

With regard to FIG. 7, an illustration of an illustrative result of deskewing an object by an imaging system according to the principles is shown. As shown, a stereoscopic camera system 702 may capture two different images of a scene containing a surface of an item or object 704. Each of the cameras of the stereoscopic camera system 702 has an off-normal axis with respect to a plane 706 of a surface (e.g., front surface of a box) the item 704. However, a processor (not shown) in communication with the stereoscopic camera system 702 may use one or more image processing algorithms to extract features from the two different images, correlate and match the extracted features while eliminating outliers, and calculate depth of the matching features or points. The processor may select a region-of-interest in the scene containing the item 704. Using depth of matching features (e.g., corners) in each of the images, the processor may determine the skew of the region-of-interest. Based on the determined skew, the processor may deskew the region-of-interest including the plane 706 of the item 704 that is normal to a virtual camera 708, where the virtual camera 708 is a position at which the camera 702 would be positioned if the camera were normal to the plane 706 of the object 704. As a result, subsequent pattern recognition processes is computationally efficient compared to conventional pattern matching algorithms that process off-normal axis images. It should be understood that the use of a virtual camera 708 is illustrative and that a virtual object may be created relative to the camera 702 and produce the same result as creating the virtual camera 708, as previously described.

One embodiment of an algorithm for performing stereo correspondence between disparate focal length images is provided hereinbelow. The algorithm may be executed by a processing unit by an imaging system or a remote processing unit, such as a local server at a retail location or on the cloud. In performing the algorithm, imager parameters, such as focal length of lens (in mm), pixel size of imager (in mm), baseline (distance between imagers, in mm), and so forth, are used.

The process may include four steps, although an alternative number of steps may also be utilized.

Step 1: SIFT-based pattern match between Image1 features and Image2 features.

SIFT matches provide a mapping between the location of a matched feature in one frame and its corresponding location in the other frame.

Step 2: Build correspondence list from matches C0

For each matching SIFT feature, a stereo correspondence point may be created using the matched feature location within the reference frame, as an offset from the frame center

Pack x,y values for each corresponding SIFT match point by:

CorrPoint.1.x=matchPoint.1.x−Center.1.x;

CorrPoint.1.y=matchPoint.1.y−Center.1.y;

CorrPoint.2.x=matchPoint.2.x−Center.2.x;

CorrPoint.2.y=matchPoint.2.y−Center.2.y;

Step 3: For each correspondence point, disparity may be calculated based on scaled difference in points considering the relative focal lengths and difference in positions, where the disparity may be used to compute real distance in millimeters, for example.

CorrPoint.xdisparity=CorrPoint.1.x−CorrPoint.2.x*(focalLength1/focalLength2);

CorrPoint.ydisparity=CorrPoint.1.y−CorrPoint.2.y*(focalLength1/focalLength2);

NOTE: Typically X-disparity is used in conjunction with the baseline (distance between imagers). To determine distance, in one embodiment of hardware, the imagers are rotated and therefore disparity for stereo distance uses the Y-space shift; with traditionally oriented images X-space may be used.

CorrPoint.distance=Baseline_mm*focalLength1/pixelSize_mm*CorrPoint.ydisparity

Step 4: To adapt for SIFT mis-matched points between frames, outlying correspondences may be removed by:
(a) removing points whose off-baseline disparity is statistically aberrant (e.g., a fixed threshold from the median may be used); and
(b) removing points whose distances are impossibly small or too distant to be included in an area of interest.

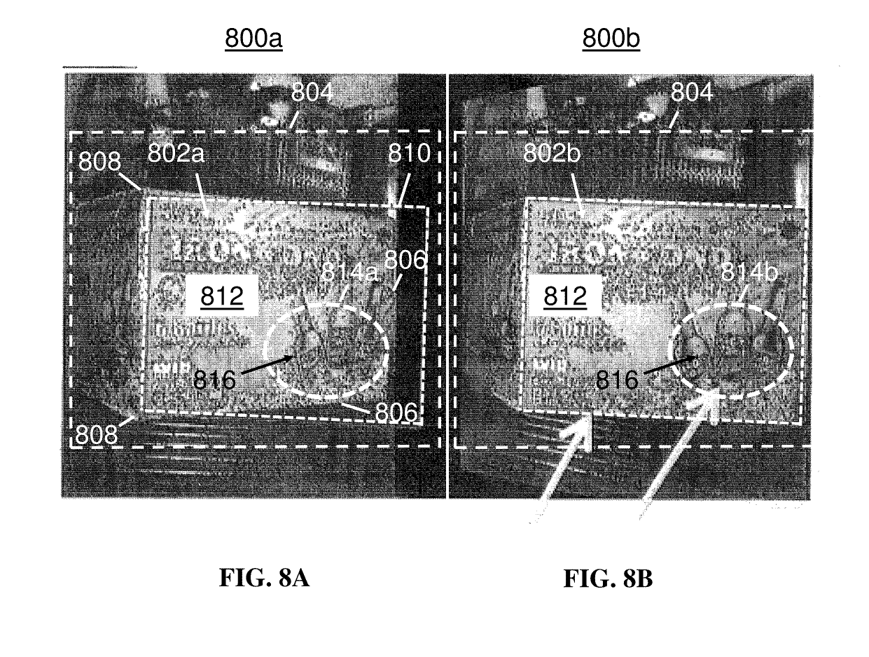

With regard to FIGS. 8A and 8B, images of illustrative scenes 800a and 800b of a skewed object 802a and a deskewed object 802b are shown. The scene 800a may be subdivided to a region-of-interest 804 within which the skewed object 802a is included. There may be a variety of techniques for establishing the region-of-interest 804, as understood in the art. The object 802a may be defined by a number of features, including edges 806 and corners 808 that a pattern recognition process, such as a SIFT algorithm, may identify. As shown, the image 800a shows the skewed object 802a being skewed as a result of being non-normal with respect to a camera, and an illustrative deskewed outline 810 that is illustrative of a front face 812 of the object 802a when deskewed, as shown in FIG. 8B. The image of the deskewed object 802b is used to improve visual pattern recognition as compared to the image of the skewed object 802a. A feature region 814a includes various pattern recognition features, in this case printed features (e.g., bottles, grapes, etc.), that a visual feature recognition algorithm may use to positively determine a specific object. As shown in the feature region 814a, printed features 816 may be difficult to identify due to the skew of the skewed object 802a. However, after the image of the skewed object 802a is deskewed utilizing the principles previously described, a feature region 814b is much clearer and shows more details of the printed features 816 that may be used by a pattern recognition algorithm. It should be understood that additional and/or alternative image features of the front face 812 may be utilized. It should further be understood that rather than identifying printed features, that physical features (e.g., protrusions and indentations) may be utilized by a feature recognition algorithm to compare to a model set of images of objects.

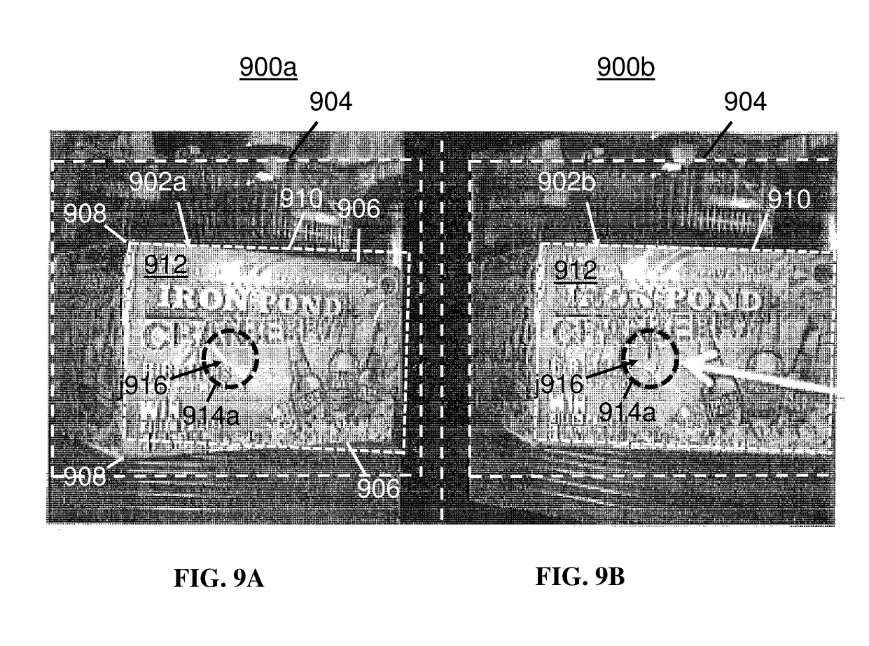

With regard to FIGS. 9A and 9B, images of illustrative scenes 900a and 900b of a skewed object 902a and a deskewed object 902b are shown. The scene 900a may be subdivided to a region-of-interest 904 within which the skewed object 902a is included. There may be a variety of techniques for establishing the region-of-interest 904, as understood in the art. The image of the skewed object 902a may be defined by a number of features, including edges 906 and corners 908 that a pattern recognition process, such as a SIFT algorithm, may identify. As shown, the image 900a shows the skewed object 902a being skewed as a result of being non-normal with respect to a camera that captured the image 900a, and an illustrative deskewed outline 910 that is illustrative of a front face 912 of the skewed object 902a, as shown in FIG. 9B. The image of the deskewed object 902b is used to improve digital watermark matching, as compared to using the image of the skewed object 902a. A feature region 914a includes various digital watermark features 914, in this case a feature that is not visible in the image of the skewed object 902a, but visible in the image in the deskewed object 902b. As shown in the feature region 914a, printed features 916 may be difficult to identify due to the skew of the skewed object 902a. However, after the image of the skewed object 902a is deskewed utilizing the principles previously described, a feature region 914b is much clearer and shows more details of the printed features 916 that may be used by a pattern recognition algorithm. It should be understood that additional and/or alternative image features of the front face 912 may be utilized. It should further be understood that rather than identifying printed features, that physical features (e.g., protrusions and indentations) may be utilized by a feature recognition algorithm to compare to a model set of images of objects.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

The previous description is of a preferred embodiment for implementing the invention, and the scope of the invention should not necessarily be limited by this description. The scope of the present invention is instead defined by the following claims.

What is claimed:

1. A method of identifying an object, comprising:
capturing a first image having a first depth-of-field and a second image having a second depth-of-field of a scene containing an object;
extracting features of the object from each of the first and second images;
correlating the first image with the second image using the extracted features from the respective images;
calculating depth of the extracted features;
selecting at least one region-of-interest from the scene inclusive of the object;
determining skew of the region-of-interest based on the depths of the extracted features;
deskewing the region-of-interest based on the determined skew; and
pattern matching to identify the object using the deskewed object captured in the image.

2. The method according to claim 1, further comprising setting a first camera with the first depth-of-field, and setting a second camera with the second depth-of-field.

3. The method according to claim 1, wherein deskewing the region-of-interest includes virtually rotating a camera that captured the images relative to the object to reduce or eliminate skew of the object relative to the camera.

4. The method according to claim 1, wherein pattern matching includes performing a visual pattern recognition.

5. The method according to claim 1, wherein extracting features includes performing a scale invariant feature transformation (SIFT) on each of the first and second images.

6. The method according to claim 5, further comprising removing outlier features in Y-space.

7. The method according to claim 6, further comprising scaling remaining extracted features to a common coordinate space, and using the scaled remaining extracted features to compute depth for each point that is determined to correlate between the first and second images.

8. The method according to claim 1, further comprising:
determining whether the skew is below a skew threshold angle; and
if the skew is determined to be below the skew threshold angle, perform pattern matching without deskewing;
otherwise, performing deskewing.

9. The method according to claim 1, further comprising:
imaging a structured light source onto the scene;
sensing the structured light source on the scene; and
determining depth based on the sensed structured light source.

10. A system for identifying an object, comprising:
a first optical component having a first depth-of-field;
a second optical component having a second depth-of-field;
a sensor configured to capture a first image from the first optical component with the first depth-of-field and a second image from the second optical component with the second depth-of-field;
a processing unit in communication with said sensor, and configured to:
extract features of the object from each of the first and second images;
correlate the first image with the second image using the extracted features from the respective images;
calculate depth of the extracted features;
select at least one region-of-interest from the scene inclusive of the object;
determine skew of the region-of-interest based on the depths of the extracted features;
deskew the region-of-interest based on the determined skew; and
pattern match to identify the object using the deskewed object captured in the image.

11. The system according to claim 10, wherein the first optical component is part of a set of optical components that defines the first depth-of-field, and wherein the second optical component is part of a set of optical components that defines the second depth-of-field.

12. The system according to claim 10, wherein said processing unit, in deskewing the region-of-interest, is further configured to virtually rotate the camera relative to the object to reduce or eliminate skew of the object relative to the camera.

13. The system according to claim 10, wherein said processing unit in pattern matching is further configured to perform a visual pattern recognition.

14. The system according to claim 10, wherein said processing unit in extracting features is further configured to perform a scale invariant feature transformation on each of the first and second images.

15. The system according to claim 14, wherein said processing unit is further configured to remove outlier features in Y-space.

16. The system according to claim 15, wherein said processing unit is further configured to:
scale remaining extracted features to a common coordinate space; and
use the scaled remaining extracted features to compute depth for each point that is determined to correlate between the first and second images.

17. The system according to claim 10, wherein said processing unit is further configured to:
determine whether the skew is below a skew threshold angle; and
if the skew is determined to be below the skew threshold angle, perform pattern matching without deskewing;
otherwise, performing deskewing.

18. The system according to claim 10, wherein said processing unit is further configured to:
image a structured light source onto the scene;
sense the structured light source on the scene; and
determine depth based on the sensed structured light source.

19. A method of identifying an object, comprising:
transmitting a structured light pattern onto a scene in which an object is positioned;
sensing the structured light pattern on the scene;
determining depth based on the sensed structured light;
selecting at least one region-of-interest from the scene inclusive of the object;
determining skew of the region-of-interest based on the depths of a plurality of points within the region-of-interest;
deskewing the region-of-interest based on the determined skew; and
pattern matching to identify the object using the deskewed region-of-interest.

20. The method according to claim 19, further comprising:
determining whether the skew is below a skew threshold angle; and
if the skew is determined to be below the skew threshold angle, performing pattern matching without deskewing;
otherwise, performing deskewing.
